(19) United States
(12) Patent Application Publication
(10) Pub. No.: US 2024/0140167 A1
(43) Pub. Date: May 2, 2024

(54) THERMAL PRECONDITIONING OF A VEHICLE

(71) Applicant: GM Global Technology Operations LLC, Detroit, MI (US)

(72) Inventor: Pui Ho Ng, Markham (CA)

(21) Appl. No.: 17/974,721

(22) Filed: Oct. 27, 2022

(51) Int. Cl. B60H 1/00

(52) U.S. Cl. CPC B60H 1/00771; B60H 1/0075; B60H 1/00878; B60R 25/24

(57) ABSTRACT

A method and apparatus for thermally preconditioning a vehicle may include tracking a position of a user and determining a trajectory of the user based upon the user's position, classifying the user's trajectory as a vehicle approach, validating the vehicle approach, and thermally preconditioning the vehicle when the vehicle approach is validated.

### INTRODUCTION

The subject disclosure relates to vehicle preconditioning.

Vehicle cabin preconditioning may include preheating or precooling interior spaces and surfaces. For example, remote vehicle starting requests through key fobs and/or smart phones may preheat or cool cabin air and preheat or cool/ventilate seating surfaces.

### SUMMARY

In one exemplary embodiment, a method for thermally preconditioning a vehicle may include tracking a position of a user and determining a trajectory of the user based upon the user's position, classifying the user's trajectory as a vehicle approach, validating the vehicle approach, and thermally preconditioning the vehicle when the vehicle approach is validated.

In addition to one or more of the features described herein, the method for thermally preconditioning the vehicle may further include determining an arrival time of the user at the vehicle, wherein a completion of the thermally preconditioning the vehicle converges with the arrival time.

In addition to one or more of the features described herein, tracking the user's position may include tracking a position of mobile device of the user.

In addition to one or more of the features described herein, tracking the user's position may include tracking a position of a key fob of the user.

In addition to one or more of the features described herein, classifying the user's trajectory as a vehicle approach may be based on a distance of the user's position from the vehicle and the user's trajectory.

In addition to one or more of the features described herein, classifying the user's trajectory as a vehicle approach may be based on the distance of the user's position from the vehicle being less than a predetermined distance from the vehicle and the user's trajectory being within a predetermined angle relative to a straight line between the user and the vehicle.

In addition to one or more of the features described herein, the user's position may include a site having known site mapping information, and wherein validating the vehicle approach may be based upon the known site mapping information.

In addition to one or more of the features described herein, validating the vehicle approach may be based upon a machine learning model of patterns of the user.

In addition to one or more of the features described herein, thermally preconditioning the vehicle when the vehicle approach is validated may include selectively activating heating or cooling systems of the vehicle based upon preferences of the user.

In addition to one or more of the features described herein, thermally preconditioning the vehicle when the vehicle approach is validated may include selectively activating heating or cooling systems of the vehicle in accordance with a thermal preconditioning energy budget based upon preferences of the user.

In addition to one or more of the features described herein, thermally preconditioning the vehicle when the vehicle approach is validated may include selectively activating heating or cooling systems of the vehicle in accordance with a thermal preconditioning energy budget based upon an available energy store in the vehicle.

In another exemplary embodiment, a method for thermally preconditioning a vehicle may include acquiring environmental information proximate to the vehicle including acquiring a temperature, acquiring vehicle specific information including acquiring available heating and cooling systems in the vehicle, a cold soak time of the vehicle, and an available energy store in the vehicle, acquiring preferences of a user corresponding to heating and cooling system priorities, acquiring position information of the user from one of a mobile device of the user and a key fob of the user, determining a trajectory of the user based upon the user's position information, and thermally preconditioning the vehicle when the user is approaching the vehicle based upon the user's trajectory, the thermally preconditioning the vehicle based upon the temperature, the available heating and cooling systems in the vehicle, the cold soak time of the vehicle, the available energy store in the vehicle and the preferences of the user corresponding to heating and cooling system priorities.

In addition to one or more of the features described herein, acquiring environmental information proximate to the vehicle may further include acquiring at least one of solar angle and vehicle elevation, and wherein thermally preconditioning the vehicle may be further based upon the at least one of solar angle and vehicle elevation.

In addition to one or more of the features described herein, acquiring vehicle specific information may further include acquiring at least one of orientation of the vehicle and location of the vehicle, and wherein thermally preconditioning the vehicle may be further based upon the at least one of orientation of the vehicle and location of the vehicle.

In addition to one or more of the features described herein, acquiring position information of the user from one of the mobile device of the user and the key fob of the user may include acquiring position information from at least one of GPS data, cellular data and short-range wireless communications data.

In addition to one or more of the features described herein, thermally preconditioning the vehicle may include allocating an aggregate thermal preconditioning energy budget among heating or cooling systems based upon the preferences of the user corresponding to heating and cooling system priorities.

In addition to one or more of the features described herein, thermally preconditioning the vehicle may include convergence of a completion of the thermally preconditioning the vehicle with an arrival time of the user at the vehicle.

In yet another exemplary embodiment, an apparatus for thermally preconditioning a vehicle may include heating and cooling systems in the vehicle, and a controller acquiring environmental information proximate to the vehicle, acquiring vehicle specific information, acquiring preferences of a user, acquiring position information of the user, determining a trajectory of the user based upon the user's position information, and thermally preconditioning the vehicle with the heating or cooling systems in the vehicle when the user is approaching the vehicle based upon the user's trajectory.

In addition to one or more of the features described herein, the user's position information may be acquired from at least one of a mobile device of the user and a key fob of the user.

In addition to one or more of the features described herein, the thermally preconditioning the vehicle may include convergence of a completion of the thermally preconditioning the vehicle with an arrival time of the user at the vehicle.

In addition to one or more of the features described herein, the controller may be further configured to receive a user schedule, and the probability of the charging event occurring within a predetermined time frame may be further based upon the user schedule.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates exemplary vehicle hardware and a communications environment related to the presently disclosed methods and apparatus; and

FIGS. 2A and 2B illustrate a thermal preconditioning scheduler, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features. As used herein, vehicle control module, control module, module, control, controller, control unit, electronic control unit, and similar terms may include one or various combinations of one or more of Application Specific Integrated Circuit(s) (ASIC), electronic circuit(s), processor/central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, in vehicle networks, in-plant and service-related networks, and other networks remote from or off-board the vehicle. Functions of control modules as set forth in this disclosure may be performed in a distributed control architecture among several networked control modules. Software, firmware, programs, instructions, routines, code, algorithms and similar terms mean any controller executable instruction sets including calibrations, data structures, and look-up tables. A vehicle control module (VCM) may have a set of control routines executed to provide described functions. Routines may be executed, such as by a processor, and are operable to monitor inputs from sensing devices and other networked control modules and execute control and diagnostic routines to control operation of actuators. Routines may be executed at regular intervals during ongoing vehicle operation or during periods of vehicle inactivity. Alternatively, routines may be executed in response to occurrence of an event, software calls, or on demand via user interface inputs or requests.

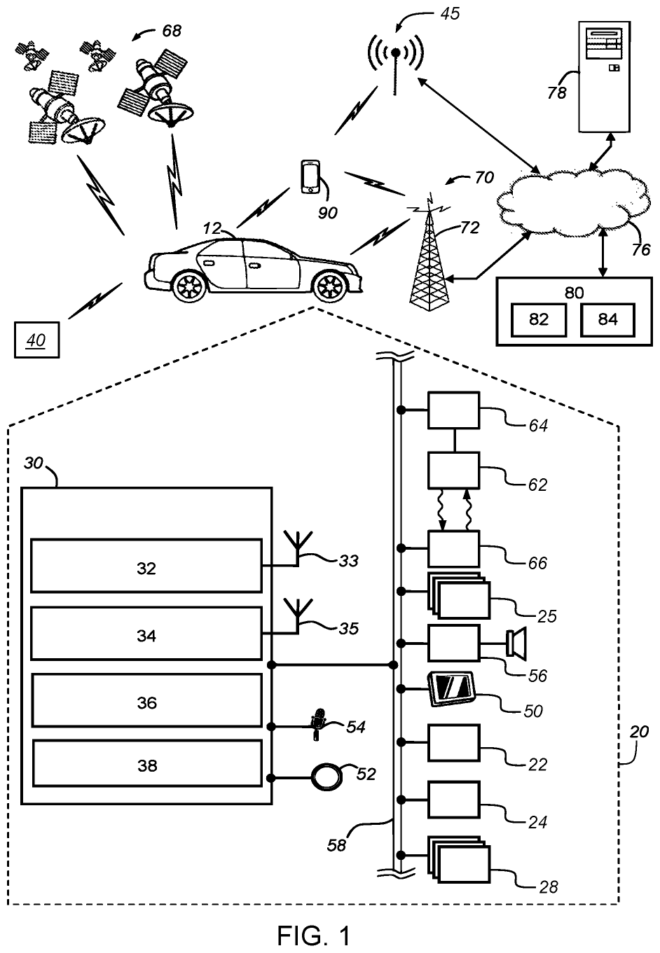

With reference to FIG. 1, exemplary vehicle hardware and a communications environment related to the presently disclosed methods and apparatus are illustrated. A vehicle 12 is depicted as a passenger car, but it should be appreciated that any other vehicle including motorcycles, trucks, sports utility vehicles (SUVs), recreational vehicles (RVs), marine vessels, aircraft, etc., may also be used. Some of the vehicle hardware 20 is shown generally in FIG. 1 and may include a variety of networked (VCMs) such as a global navigation satellite system (GNSS) receiver 22, a body control module (BCM) 24, a wireless communications device 30, vehicle-user interfaces 50-56, an RESS including a battery pack 62, a battery management system including a battery pack control module (BPCM) 64, a battery pack thermal management system (TMS) 66, and other VCMs 28 performing functions related to various vehicle systems (e.g., chassis, steering, braking, communications, navigation, infotainment, energy management, propulsion, etc.). Some or all of the different vehicle hardware may be coupled for communication with each other via one or more communication bus 58. Communication bus 58 may provide the vehicle electronics with network connections using one or more network protocols. Examples of suitable network connections include a controller area network (CAN), a media oriented system transfer (MOST), a local interconnection network (LIN), a local area network (LAN), and other appropriate network connections such as Ethernet or others that conform with known ISO, SAE and IEEE standards and specifications, to name but a few. In other embodiments, each of the VCMs may communicate using a wireless network and may include suitable hardware, such as short-range wireless communications (SRWC) circuitry.

In the illustrated embodiment, the vehicle 12 is a battery electric vehicle (BEV) that may use the RESS for propulsion as well as other vehicle electrical loads. The BPCM 64 may be integrated with a propulsion system control module for managing BEV powertrain functions, including controlling wheel torque and battery pack charging. In other embodiments, the vehicle 12 may be a hybrid (e.g., a plug-in hybrid electric vehicle (PHEV)) or an internal combustion engine (ICE) vehicle. The battery pack 62 for BEVs and PHEVs may include at least one high voltage battery module, for example at about 400 volts nominal terminal voltage. The battery pack 62 may include multiple high voltage battery modules. Multiple high voltage battery modules may be configured in parallel during vehicle propulsion periods and in series during recharging periods. High voltage battery modules primarily service vehicle propulsion system components such as traction motors. Certain high-power vehicle accessory loads, for example electrically driven air conditioning compressors or vehicle cabin heaters, may also be serviced by high voltage battery modules. BEVs and PHEVs may include at least one low voltage battery module, for example about 12 volts nominal terminal voltage. A low voltage battery module may service vehicle loads requiring voltages substantially below the voltage of the high voltage battery modules. Such vehicle loads may include, for example, engine starting, vehicle lighting, infotainment, accessory motors, resistive or PTC heating loads such as glass defroster/deicer or seat heaters, and control electronics including various VCMs. ICE vehicles may only include a low voltage battery module to service low voltage vehicle loads. The RESS may include a battery disconnect unit (BDU) (not illustrated) to effect various reconfigurations of and among multiple battery modules of a battery pack 62. For example, a BDU may selectively configure high voltage battery modules of a battery pack 62 at one overall terminal voltage (e.g., 400 volts) for propulsion and at another overall terminal voltage (e.g., 800 volts) for off-board DC fast charging (DCFC). A BDU may be integrated into one or more controllable units, or physically and functionally distributed variously within components or subsystems, for example within battery pack 62 containment packaging.

The BPCM 64 may monitor various metrics within the battery pack including, for example, battery pack 62 (including battery modules and battery cells) voltage, current and temperature. The BPCM 64 may determine from such metrics state of charge (SOC), state of health (SOH), and temperature of the battery pack 62 (including battery modules and battery cells). SOC may be used to determine battery pack range in accordance with known algorithms and models considering historical usage, driving patterns, planned trip routes, and other metrics.

The battery pack TMS 66 may include bi-directional heat transfers into and out of the battery pack 62. The battery pack TMS 66 may include, for example, a cooling plate for dissipating heat from the battery pack and positive thermal coefficient (PTC) heating devices, both preferably integrated within the battery pack 62 beneath or between battery modules. Other heating technologies including resistive heating may be employed. The cooling plate may include fluid circulated therethrough and through an external cooling circuit. The cooling circuit may include an electrically driven refrigerant compressor. The battery pack 62 is the source of electrical energy for heating and cooling the battery pack, both of which will result in reduction of battery pack 62 charge and SOC reduction. The battery pack TMS 66 may include an integrated controller or one or more VCMs, including BCM 24 or BPCM 64 to implement controls related to the battery pack thermal management. For example, the BPCM 64 may control electrical heating of the battery pack by controlling the conductive states of the PTC heating devices. The BPCM 64 may control battery pack cooling by controlling the state of cooling circuit fluid flow. It is appreciated that target temperatures for the battery pack may be achieved by way of the controllable battery pack heating and cooling apparatus of the battery pack TMS.

The VCMs may receive input from one or more sensors and shared bus data, and use the inputs to perform diagnostic, monitoring, control, reporting, and/or other functions related to various vehicle systems. Each of the VCMs 28 is connected by communication bus 58 to the other VCMs, as well as to the wireless communications device 30. One or more VCMs 28 may periodically or occasionally have their software or firmware updated and, in some embodiments, such updates may be over the air (OTA) updates that are received from a computer 78 or backend facility 80 via remote network 76 and communications device 30. Remote network 76 is understood to be off the vehicle 12. As is appreciated by those skilled in the art, the above-mentioned VCMs are only examples of some of the modules that may be used in vehicle 12.

Wireless communications device 30 is capable of communicating data via short-range wireless communications (SRWC) through use of a SRWC circuit 32 and/or via cellular network communications through use of a cellular chipset 34, as depicted in the illustrated embodiment. In one embodiment, the wireless communications device 30 is a VCM that may be used to carry out at least part of the methods disclosed herein. In the illustrated embodiment, wireless communications device 30 includes an SRWC circuit 32, cellular chipset 34, a processor 36, memory 38, and antennas 33 and 35. In one embodiment, wireless communications device 30 may be a standalone module or, in other embodiments, wireless communications device 30 may be incorporated or included as a part of one or more other VCMs, such as a center stack module (CSM), a body control module BCM 24, an infotainment module, a head unit, and/or a gateway module. The wireless communications device 30 may be integrated with the GNSS receiver 22 so that, for example, the GNSS receiver 22 and the wireless communications device 30 are directly connected to one another as opposed to being connected via communication bus 58.

In some embodiments, the wireless communications device 30 may be configured to communicate wirelessly according to one or more short-range wireless communications (SRWC) protocols such as any of the Wi-Fi™, WiMAX™, Wi-Fi Direct™, other IEEE 802.11 protocols, ZigBee™, Bluetooth™, Bluetooth™ Low Energy (BLE), Ultra-wideband, or near field communication (NFC). The short-range wireless communication (SRWC) circuit 32 enables the wireless communications device 30 to transmit and receive SRWC signals. The SRWC circuit may allow the device 30 to connect to another SRWC device. Additionally, in some embodiments, the wireless communications device may contain a cellular chipset 34 thereby allowing the device to communicate via one or more cellular protocols, such as those used by a cellular carrier system 70. In such a case, the wireless communications device becomes user equipment (UE) usable in carrying out cellular communications via cellular carrier system 70.

Wireless communications device 30 may enable vehicle 12 to be in communication with one or more key fobs 40 through the SRWC circuit 32 and SRWC protocols. The key fob 40 and SRWC circuit 32 together may provide a passive entry passive start (PEPS) system for passive detection of the absence or presence of the key fob 40 enabling secure access and operation of the vehicle 12. It is understood that the PEPS system may rely upon a SRWC PEPS module that is separate or standalone from the wireless communications device 30.

Wireless communications device 30 may enable vehicle 12 to be in communication with one or more users' mobile devices 90 such as a smart phone through the SRWC circuit 32 and SRWC protocols and/or through the cellular chipset 34 and cellular protocols over a cellular carrier system 70. The user's mobile device 90 may include SRWC capabilities (e.g., Wi-Fi™, Bluetooth™) and cellular capabilities.

Wireless communications device 30 may enable vehicle 12 to be in communication with one or more remote networks 76 and one or more backend facility 80 or computer 78 via packet-switched data communication. This packet-switched data communication may be carried out through use of an off-vehicle wireless access point 45 that is connected, for example, to a wide area network via a router or modem. When used for packet-switched data communication such as TCP/IP, the communications device 30 may be configured with a static IP address or may be set up to automatically receive an assigned IP address from another device on the network such as a router or from a network address server. Packet-switched data communications may also be carried out via use of a cellular network that may be accessible by the device 30. Communications device 30 may, via cellular chipset 34, communicate data over cellular carrier system 70. In such an embodiment, radio transmissions may be used to establish a communications channel, such as a voice channel and/or a data channel, with cellular carrier system 70 so that voice and/or data transmissions may be sent and received over the channel. Data may be sent either via a data connection, such as via packet data transmission over a data channel, or via a voice channel using techniques known in the art. For combined services that involve both voice communication and data communication, the system may utilize a single call over a voice channel and switch as needed between voice and data transmission over the voice channel, all of which may be done using techniques known to those skilled in the art. Similarly, the user's mobile device 90 may be in communication with one or more remote networks 76 and one or more backend facility 80 or computer 78 via packet-switched data communication. This packet-switched data communication may be carried out through use of an off-vehicle wireless access point 45 and/or cellular networking. Off-vehicle wireless access points 45 may be private (such as residential wireless local area networks (WLAN)) or public (such as retailer/business/municipal provided open access WLAN).

Processor 36 may be any type of device capable of processing electronic instructions including microprocessors, microcontrollers, host processors, controllers, vehicle communication processors, ASICs, etc. It may be a dedicated processor used only for communications device 30 or may be shared with other vehicle systems. Processor 36 may execute various types of digitally-stored instructions, such as software or firmware programs stored in memory 38, which enable the device 30 to provide a wide variety of services. For instance, processor 36 may execute programs or process data to carry out at least a part of the methods discussed herein. Memory 38 may be a temporary powered memory, any non-transitory computer readable medium, or other type of memory. For example, the memory may be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives. Similar components to those previously described (processor 36, memory 38, SRWC circuit 32 and cellular chipset 34) may be included in other VCMs, including BCM 24 and BPCM 64.

The wireless communications device 30 is connected to the bus 58, and may receive data from one or more onboard vehicle sensors, shared bus data, and user inputs. The vehicle may send this data (or other data derived from or based on this data) to other devices or networks, including remote networks 76 and one or more backend facility 80 or computer 78. And, in another embodiment, the wireless communications device 30 may be incorporated with or connected to a navigation system that includes geographical map information including geographical roadway map data and compass information. The navigation system may be communicatively coupled to the GNSS receiver 22 (either directly or via communication bus 58) and may include an on-board geographical map database that stores local geographical map information. This local geographical map information may be provisioned in the vehicle and/or downloaded via a remote connection to a geographical map database/server, such as computer 78 and/or backend facility 80 (including servers 82 and databases 84). The on-board geographical map database may store geographical map information corresponding to a location or region of the vehicle so as to not include a large amount of data. Moreover, as the vehicle 12 enters different locations or regions, the vehicle may inform the vehicle backend services facility 80 of the vehicle's location (e.g., obtained via use of GNSS receiver 22) and, in response to receiving the vehicle's new location, the servers 82 may query databases 84 for the corresponding geographical map information, which may then be sent to the vehicle 12.

GNSS receiver 22 receives radio signals from a constellation of GNSS satellites. As known in the art, GNSS receiver 22 may be configured for operation within a given geopolitical region (e.g., country). The GNSS receiver 22 may be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 68. And, in another example, GNSS receiver 22 may be a BDS receiver that receives a plurality of BDS signals from a constellation of BDS satellites 68. In any implementation, GNSS receiver 22 may include at least one processor and memory, including a non-transitory computer readable memory storing instructions (software) that are accessible by the processor for carrying out the processing performed by the GNSS receiver 22.

GNSS receiver 22 may be used to provide navigation and other position-related services to the vehicle operator and systems. Navigation information may be presented on the display 50 (or other display within the vehicle such as an application program on the user's mobile device 90 or a head-up display) or may be presented verbally such as is done when supplying turn-by-turn navigation. The navigation services may be provided using a dedicated in vehicle navigation module (which may be part of GNSS receiver 22 and/or incorporated as a part of wireless communications device 30 or other VCM), or some or all navigation services may be done via the wireless communications device 30 (or other telematics-enabled device) installed in the vehicle, wherein the position or location information is sent to a remote location for purposes of providing the vehicle with navigation maps, map annotations and geographic information system (GIS) data (points of interest, restaurants, etc.), route calculations, and the like. These remote locations may be the vehicle backend services facility 80 or other remote computer system, such as computer 78. Also, new updated map data, such as that geographical roadway map data stored on databases 84, may be downloaded to the GNSS receiver 22 (or other VCM) from the backend facility 80 via vehicle communications device 30.

BCM 24 may be used to control various other VCMs of the vehicle, as well as obtain information concerning other VCMs, including their present state or status, and sensor information. BCM 24 is shown in the exemplary embodiment of FIG. 1 as being electrically coupled to communication bus 58. In some embodiments, the BCM 24 may be integrated with or as part of a center stack module (CSM) and/or integrated with the wireless communications device 30. BCM 24 may include a processor and memory, which may be similar to processor 36 and memory 38 of wireless communications device 30, as disclosed herein. BCM 24 may communicate with wireless device 30, an audio system 56, BPCM 64, TMS 66, and other VCMs 28. BCM 24 may include a processor and memory accessible by the processor. Suitable memory may include non-transitory computer-readable memory that includes various forms of non-volatile RAM and ROM. Software stored in the memory and executable by the processor enables the BCM to direct one or more vehicle functions or operations including, for example, controlling central locking, heating/ventilation/air conditioning (HVAC) functions, power mirrors, and/or controlling various other vehicle modules and systems. For example, the BCM 24 may send signals to other VCMs, such as a request to perform a particular operation or a request for sensor information and, in response, the sensor may then send back the requested information. In ICE vehicles, the BCM may request an engine start for sourcing HVAC heat from engine coolant and HVAC cooling from a belt driven air conditioning compressor. In an embodiment, systems that may be used to effect thermal preconditioning may be managed by the BCM 24. Such systems may include non-limiting examples of the HVAC system (heat/cool/airflow/zoning), thermally regulated seats, arm rests, neck scarf, leg cooler/warmer, steering wheel, electrically controlled tinting/reflectivity (e.g., smart glass) and windows and sunroofs. Such heating and cooling systems are represented at 25 in FIG. 1 and may be referred to as thermal preconditioning systems. The BCM 24 may receive data from VCMs, battery pack 62 information from BPCM 64, battery pack thermal management information from TMS 66, and various other vehicle component and system information from other VCMs. The data may be sent to the wireless communications device 30 automatically upon receiving a request from the device/computer, automatically upon certain conditions being met, or periodically (e.g., at set time intervals). As discussed in more detail below, the BCM 24 may be configured with one or more triggers that, when a condition is satisfied, the BCM performs some operation, such as sending sensor information to the wireless communications device 30 (or to another device or entity, such as backend facility 80). In this way, the BCM 24 may filter information based on predetermined or predefined triggers and pass the filtered information on to other VCMs, including the wireless communications device 30.

The vehicle 12 includes a plurality of vehicle sensors related to various vehicle systems, components and environment. Also, certain vehicle-user interfaces 50-56 may be utilized to interface with a user. Generally, the sensors may obtain information pertaining to either the operating state of the vehicle (the “vehicle operating state”) or the environment of the vehicle (the “vehicle environmental state”). The sensor information may be sent, for example, to BCM 24, BPCM 64, TMS 66, the vehicle communications device 30, and other VCMs 28, via communication bus 58. Also, in some embodiments, the sensor data may be sent with metadata, which may include data identifying the sensor (or type of sensor) that captured the sensor data, a timestamp (or other time indicator), and/or other data that pertains to the sensor data, but that does not make up the sensor data itself. The “vehicle operating state” refers to a state of the vehicle concerning the operation of the vehicle, which may include the operation of the propulsion system. Additionally, the vehicle operating state may include the vehicle state concerning mechanical operations of the vehicle or electrical states of the vehicle. The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle.

Vehicle-user interfaces 50-56 may provide vehicle occupants with a means of receiving and providing information, including visual display 50, pushbutton(s) 52, microphone 54, and audio system 56. As used herein, the term “vehicle-user interface” broadly includes any suitable device, including both hardware and software components, located on the vehicle and enables a vehicle user to communicate with or through a component of the vehicle. Vehicle-user interfaces 50-56 are also onboard vehicle sensors that may receive input from a user or other sensory information. The pushbutton(s) 52 allow manual user input into the communications device 30 to provide other data, response, or control input. Audio system 56 provides audio output to a vehicle occupant and may be a dedicated, standalone system or part of the primary vehicle audio system. According to the particular embodiment shown here, audio system 56 is operatively coupled to both communication bus 58 and an entertainment bus (not shown) and may provide AM, FM and satellite radio, CD, DVD and other multimedia functionality. This functionality may be provided in conjunction with or independent of an infotainment module. Microphone 54 provides audio input to the wireless communications device 30 to enable the driver or other occupant to provide voice commands and/or carry out hands-free calling via the cellular carrier system 70. For this purpose, it may be connected to an on-board automated voice processing unit utilizing human-machine interface (HMI) technology (e.g., dialogue manager) known in the art. Visual display 50 is preferably a graphics display and may be used to provide a multitude of input and output functions. Visual display 50 may be a touch screen on the instrument panel, or a head up display, for example. Various other vehicle-user interfaces may also be utilized, such as the user's mobile device 90, as the interfaces of FIG. 1 are exemplary and not limiting.

A user of the vehicle 12 may use one or more vehicle-user interfaces 50-56 to input information such as preferences and settings for various vehicle system customizations. In one embodiment, the user may operate one or more vehicle-user interfaces 50-56, which may then deliver inputted information, for example, to BCM 24, BPCM 64, TMS 66, the vehicle communications device 30, and other VCMs 28. The wireless communications device 30, for example, may then send this information to the backend facility 80 using the cellular chipset 34 or other communications means.

Cellular carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers (MSC), base station controllers, evolved nodes (e.g., eNodeBs), mobility management entities (MMEs), serving and PGN gateways, etc., as well as any other networking components required to connect cellular carrier system 70 with the remote network 76 or to connect the wireless carrier system with user equipment (UEs, e.g., which may include telematics equipment in vehicle 12 and the user's mobile device 90). Carrier system 70 may implement any suitable communications technology, including GSM/GPRS or CDMA or CDMA2000 (i.e., 2G & 3G), LTE (i.e., 4G), 5G etc. In general, wireless carrier systems 70, their components, the arrangement of their components, the interaction between the components, etc. is generally known in the art.

Apart from using cellular carrier system 70, a different wireless carrier system in the form of satellite communication may be used to provide uni-directional or bi-directional communication with the vehicle. This may be done using one or more communication satellites (not shown) and an uplink transmitting station (not shown). Uni-directional communication may be, for example, satellite radio services, wherein programming content (news, music, etc.) is received by the uplink transmitting station, packaged for upload, and then sent to the satellite, which broadcasts the programming to subscribers. Bi-directional communication may be, for example, satellite telephony services using the one or more communication satellites to relay telephone communications between the vehicle 12 and the uplink transmitting station. If used, this satellite telephony may be utilized either in addition to or in lieu of cellular carrier system 70.

Remote network 76 may be a conventional land-based telecommunications network that connects cellular carrier system 70 to vehicle backend services facility 80. For example, remote network 76 may include a public switched telephone network (PSTN) or mobile switching centers (MSC) such as that used to provide hardwired telephony, packet-switched data communications, and the Internet infrastructure including access to public and private resources. Public and private resources accessible via the Internet infrastructure may include, for example, GPS matched weather information (e.g., temperature, relative humidity, cloud cover, etc.) and solar angles (e.g., American Society of Heating, Refrigerating and Air-Conditioning Engineers (ASHRAE) database). One or more segments of remote network 76 could be implemented through the use of a standard wired network, a fiber or other optical network, a cable network, power lines, other wireless networks such as wireless local area networks (WLANs), or networks providing broadband wireless access (BWA), or any combination thereof.

Computer 78 includes at least one processor and memory and may be accessible via a private or public network such as the Internet. In one embodiment, computer 78 may be used for one or more purposes, such as for providing navigational services to a plurality of vehicles and other electronic network computing devices, including the vehicle 12 and the user's mobile device 90. Computer 78 may be, for example: a service center computer where diagnostic information and other vehicle data (e.g., vehicle specific factors) may be uploaded from the vehicle for remote data processing services (i.e., cloud computing resources) related to the vehicle 12 as further described herein; a client computer used by the vehicle owner or other subscriber for such purposes as accessing, receiving and provisioning vehicle data (e.g., vehicle option configuration), setting up or configuring subscriber preferences, updating and maintaining vehicle assets including VCMs software; or a third party repository to or from which vehicle data or other is provided, whether by communicating with the vehicle 12, backend facility 80, or both. A computer 78 may also be used for providing Internet connectivity such as DNS services or as a network address server that uses DHCP or other suitable protocol to assign an IP address to the vehicle 12 or the user's mobile device 90.

Vehicle backend services facility 80 is a backend facility and is located at a physical location that is located remotely from vehicle 12. The vehicle backend services facility 80 (or “backend facility 80” for short) may be designed to provide the vehicle hardware 20 with a number of different system back-end functions through use of one or more electronic servers 82 and, in many cases, may provide navigation-related services to a plurality of vehicles. In one embodiment, the backend facility 80 provides route suggestions (or a planned route). The vehicle backend services facility 80 includes vehicle backend services servers 82 and data bases 84, which may be stored on a plurality of memory devices. Vehicle backend services facility 80 may include any or all of these various components and, preferably, each of the various components are coupled to one another via a wired or wireless local area network. Backend facility 80 may receive and transmit data via a modem connected to remote network 76. Data transmissions may also be conducted by wireless systems, such as IEEE 802.11x, GPRS, and the like. Those skilled in the art will appreciate that, although only one backend facility 80 and one computer 78 are depicted in the illustrated embodiment, numerous remote facilities 80 and/or computers 78 may be used. Moreover, a plurality of backend facilities 80 and/or computers 78 may be geographically distributed and may each coordinate information and services with one another, as those skilled in the art will appreciate.

Server 82 and computer 78 may be computers or other computing devices that include at least one processor and that include memory. The processors may be any type of device capable of processing electronic instructions including microprocessors, microcontrollers, host processors, controllers, vehicle communication processors, and ASICs. The processors may be dedicated processors used only for server 82 or computer 78 or may be shared with other systems. The at least one processor may execute various types of digitally-stored instructions, such as software or firmware, which enable the server 82 or computer 78 to provide a wide variety of services. This software may be stored in computer-readable memory and may be any suitable non transitory, computer-readable medium. For example, the memory may be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives. For network communications (e.g., intra-network communications, inter-network communications including Internet connections), the servers may include one or more network interface cards (NICs) (including wireless NICs (WNICs)) that may be used to transport data to and from the computers. These NICs may allow the one or more servers 82 or computers 78 to connect with one another, databases 84, or other networking devices, including routers, modems, and/or switches. In one particular embodiment, the NICs (including WNICs) of servers 82 or computers 78 may allow SRWC connections to be established and/or may include Ethernet (IEEE 802.3) ports to which Ethernet cables may be connected to that may provide for a data connection between two or more devices. Backend facility 80 may include a number of routers, modems, switches, or other network devices that may be used to provide networking capabilities, such as connecting with remote network 76 and/or cellular carrier system 70.

Databases 84 may be stored on a plurality of memory, such as a powered temporary memory or any suitable non-transitory, computer-readable medium. For example, the memory may be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. One or more databases at the backend facility 80 may store various information and may include geographical roadway information databases, and other vehicle information databases.

In accordance with the present disclosure, a thermal preconditioning of the vehicle 12 in anticipation of a user occupation may be accomplished through a variety of manual or automated invocations. In a manual invocation, a user may manually request thermal preconditioning of the vehicle 12 in preparation for an incipient vehicle occupation. In an automated invocation, the user is not generally and ongoingly directly involved in requesting thermal preconditioning of the vehicle 12; rather, an automated system may be responsible for invoking thermal preconditioning of the vehicle 12 in preparation for an occupation, for example based upon one or more of user location and approach of the vehicle, site specific user location, user schedules or habits.

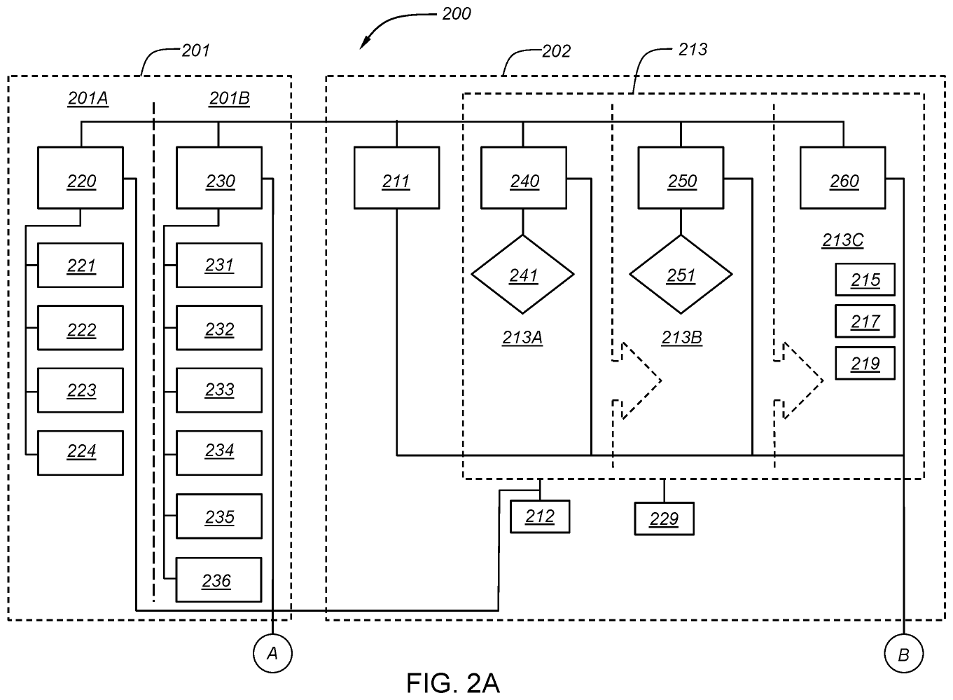

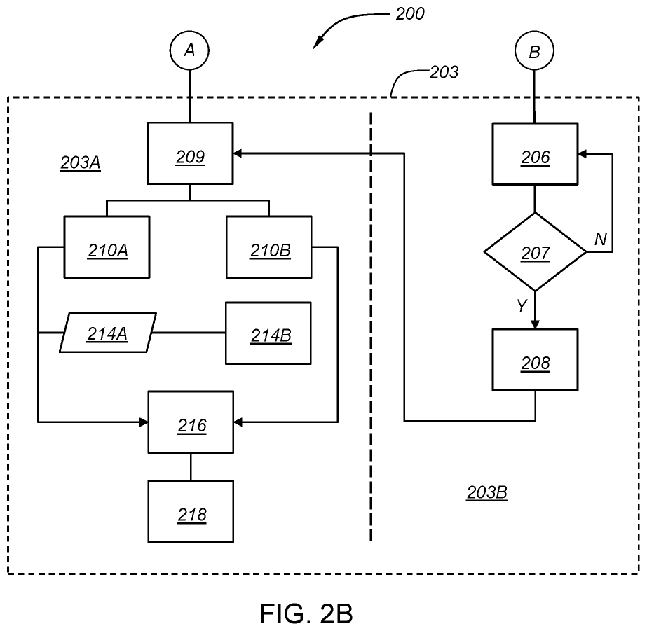

With reference to FIGS. 2A and 2B, a thermal preconditioning scheduler 200 is represented in a block diagram of relationships and flows among functional modules and steps. The thermal preconditioning scheduler 200 may be implemented in one or more processors on-board and off-board the vehicle 12 (FIG. 1) as further described herein. In one embodiment, the scheduler 200, may be implemented in a computer program (or “application”) embodied in a computer readable medium and including instructions usable by one or more processors of one or more computers of one or more systems. The computer program may include one or more software programs including program instructions in source code, object code, executable code or other formats; one or more firmware programs; or hardware description language (HDL) files; and any program related data. The data may include data structures, libraries, look-up tables, or data in any other suitable format. The program instructions may include program modules, routines, programs, objects, components, or the like. The computer program may be executed on one computer or on multiple computers in communication with one another including one or more VCMs of the vehicle 12, the user's mobile device 90, and/or computer 78 or backend facility 80 via the remote network 76.

The thermal preconditioning scheduler 200 may include a data acquisition block 201. The data acquisition block 201 may include an environmental factors module 201A and a vehicle factors module 201B. The environmental factors module 201A is primarily concerned with obtaining vehicle proximate environmental information 220 affecting the vehicle thermal conditions. For example, weather information 221 including geographically and temporally proximate temperature, relative humidity, barometric pressure and wind may be relevant. GPS matched weather information may be readily obtained from Internet resources by the vehicle 12 using the vehicle cellular communication capabilities and/or the user's mobile device 90 SRWC and/or cellular capabilities. Time and date information 222 may be readily obtained from cellular service providers or Internet resources by the vehicle 12 using the vehicle cellular communication capabilities and/or the user's mobile device 90 SRWC and/or cellular capabilities. Solar angle information 223 may be GPS matched and obtained from Internet resources (e.g., ASHRAE database) by the vehicle 12 using the vehicle cellular communication capabilities and/or the user's mobile device 90 SRWC and/or cellular capabilities. Alternatively, solar angle information 223 may be calculated from known formulas or looked up from table stores of information either on-board the vehicle 12 or off-board the vehicle 12. For example, the vehicle 12 may inform the vehicle backend services facility 80 of the vehicle's location (e.g., obtained via use of GNSS receiver 22) and, in response to receiving the vehicle's location, the servers 82 may query databases 84 for the corresponding solar angle information, which may then be sent to the vehicle 12. Vehicle elevation information 224 may be obtained from GPS data by the vehicle 12 using the vehicle 12 and/or the user's mobile device 90 GPS capabilities. The vehicle factors module 201B is primarily concerned with obtaining vehicle specific information 230 related to vehicle specific configurations and conditions. For example, the vehicle 12 option content information 231 may be obtained from remote networks 76 and one or more backend facility 80 or computer 78 by the vehicle 12 using the vehicle cellular communication capabilities and/or the user's mobile device 90 SRWC and/or cellular capabilities. Computer 78 may be, for example, a service center computer or a client computer used by the vehicle owner to access such vehicle option configuration information. Thus, the vehicle factors module 201B of thermal preconditioning scheduler 200 has knowledge of the vehicle 12 configurations and conditions relevant to thermal preconditioning. Configurations such as interior and exterior color schemes, glass area and insulation may affect solar radiation absorption and retention, hence knowledge of such characteristics informs the thermal preconditioning scheduler of the relative effects of solar loads upon the vehicle. System configurations may include non-limiting examples of active system controls such as the HVAC system (heat/cool/airflow/zoning), thermally regulated seats, arm rests, neck scarf, leg cooler/warmer, steering wheel, and passive system controls such as electrically controlled tinting/reflectivity (e.g., smart glass) and window and sunroof controlled venting. Conditions of the vehicle 12 may include ambient vehicle conditions 232 outside and within the vehicle 12 which may be obtained from vehicle sensors such as outside air temperature sensors and in cabin air temperature sensors. Vehicle orientation 233 may be obtained from in vehicle compass information for example from the vehicle 12 GNSS and navigation systems. Vehicle orientation information may be relevant in conjunction with solar angle information in determining solar heat load within the vehicle 12. Conditions of the vehicle 12 may include vehicle location information 234 which may be obtained from in vehicle GPS information. Vehicle location information may inform the thermal preconditioning scheduler 200 of vehicle exposure, for example whether the vehicle 12 is in a covered parking structure, below ground, above grade, etc. Such location information may be relevant in determining solar exposure, earth insulation, wind exposure, etc. Conditions of the vehicle 12 may include vehicle cold soak time 235 (time between operative cycles) and prior operational history (operative cycle durations) which may be obtained from shared bus data and may be relevant to determine retained heat within the aggregate thermal mass of the vehicle 12. Vehicle battery charge level, state of charge, fuel level and other metrics related to range and/or available energy stores 236 on vehicle may be obtained from shared bus data and may be relevant in conjunction with user preferences or independently to determine allocation of such energy stores to thermal preconditioning. Other environmental and vehicle factors may be accounted for by the environmental factors module 201A and a vehicle factors module 201B of the data acquisition block 201, the examples set forth above being understood as non-limiting specific examples.

The thermal preconditioning scheduler 200 may include a decision input block 202 which may include a manual based module 211 and an approach based module 213. Generally, the decision input block 202 may include user inputs including settings, preferences, customizations, requests, and the like. In one embodiment, a user may manually request, at the manual settings module 211, thermal preconditioning immediately, in accordance with some possible time delay (e.g., in 30 minutes), in accordance with a single or repetitive time/date setting (e.g., 6 a.m. on Monday mornings), in accordance with a time/date interval (e.g., odd numbered days, every third day), or in accordance with other rudimentary fixed schedule settings. In such scenarios, the user may simply provide a set-and-forget request at a manual settings module 211 that will invoke thermal preconditioning in accordance with the setting. Such manual settings may be received via the various vehicle-user interfaces 50-56 or the user's mobile device 90 (FIG. 1) and provided to the manual settings module 211. For example, user settings may be provided via push buttons 52, visual display 50, a microphone 54, audio system 56 and voice recognition/dialogue manager, the user's mobile devices 90, etc.

In other embodiments, an automated invocation of thermal preconditioning may rely upon an approach based module 213 of the decision input block 202. The approach based module 213 may rely upon user preferences, for example between or among various user specific preferences. In accordance with one embodiment a user may set or select at least one of a limited number of available preferences at a preference module 212, such as minimum battery pack range or minimum battery pack SOC. For example, a user may desire to maintain a higher battery pack charge in lieu of some or all thermal preconditioning functions. In such a scenario, the user may prioritize or select battery pack range or SOC over thermal preconditioning functions. A user may also prioritize vehicle systems utilized in thermal preconditioning. Thus, a user may rank or outright disable systems relative to thermal preconditioning controls (e.g., cabin air heating/cooling, seating ventilation/heating/cooling, steering wheel heating, armrest heating, neck warmer, leg cooling/warming, etc.) and zones (driver, front, rear, mid cabin, etc.) thereby allowing the thermal preconditioning system to shed loads in accordance with the user's priority. A simple ranked sorting of available systems may thus provide the thermal precondition control with a prioritization for use in execution. One having ordinary skill in the art will understand that personal preferences may be one-dimensional, multi-dimensional, or subject to limits and conditions. User preferences at preference module 212 may be received via various vehicle-user interfaces and provided to the approach based module 213 and manual settings module 211. For example, user settings may be provided via push buttons 52, visual display 50, a microphone 54, audio system 56 and voice recognition/dialogue manager, the user's mobile device 90, etc. User preference established at preference module 212 are accessed by various sub-functions and modules of the approach based module 213 and manual settings module 211.

In accordance with an embodiment, the approach based module 213 may include a naked approach based module 213A. The naked approach based model 213A may classify the user's trajectory as approaching the vehicle 12 at 240 using metrics 241 such as the vehicle 12 location, the user's location, the user's rate and the user's trajectory. A user's trajectory may simply be determined from changes in two-dimensional flattened GPS coordinate data and the user's rate determined from changes in two-dimensional flattened GPS coordinate data with respect to time. In one embodiment a user may be considered to be approaching the vehicle 12 when the distance from the vehicle 12 is less than a predetermined distance from the vehicle 12 and the trajectory or heading of the user is within a predetermined angle relative to a straight line between the user and the vehicle 12. In an embodiment, a user's location and trajectory may be determined by tracking the user through GPS data via the user's mobile device 90. Alternatively, a user's location and trajectory may be determined through user's key fob signal strength, triangulation or time of flight radio frequency techniques. Additionally, user's key fob may be GPS, cellular, or SRWC equipped (e.g., Wi-Fi™, Bluetooth™) thus enabling locating and trajectory determinations for the user. In an embodiment, a user's distance from the vehicle may be parsed into concentric approach zones. For example, as measured from the vehicle 12, a first near approach zone may be established within a circle whose center corresponds to the vehicle 12 and whose perimeter corresponds to a first distance from the vehicle 12. A second intermediate approach zone may be established between the perimeter of the first inner approach zone and a perimeter of a circle whose center corresponds to the vehicle 12 and whose perimeter corresponds to a second distance from the vehicle 12 that is greater than the first distance from the vehicle 12. A third outer approach zone may be established between the perimeter of the second intermediate approach zone and the perimeter of a circle whose center corresponds to the vehicle 12 and whose perimeter corresponds to a third distance from the vehicle 12 that is greater than the second distance from the vehicle 12. Such approach zoning is merely exemplary and other approach zoning techniques may be employed, for example angular oriented approach zones, alone or in combination. Approach zoning may advantageously provide sufficient control resolution and opportunity for thermal preconditioning adjustments based upon user distance from the vehicle 12 while maintaining manageable data and processing throughput of the various resources utilized in tracking the user.

In accordance with an embodiment, the approach based module 213 may include a site specific module 213B. The site specific module 213B may also classify the user's trajectory as approaching the vehicle 12 through the naked approach based module 213A. Additionally, the site specific module 213B may employ mapping information 250 useful in validating a vehicle approach based on rationality tests for example. In an embodiment, sites 251 may be identified by the position of the user as determined through GPS data. For example, the site may be a football stadium or an open air concert venue. A user's trajectory may meet conditions for classifying as a vehicle approach. However, the site may have known limited access points (i.e., entrances and exits) which are inconsistent with the user's current trajectory. Therefore, the site specific module 213B may provide additional site mapping information 250 (e.g., exit locations) related to the site 251 and relevant to validation of the vehicle approach. In an embodiment, a site may be identified by tracking the user through the position of the user as determined through known cellular triangulation or Wi-Fi™ access point locating techniques including use of Internet location services. For example, the site may be an indoor shopping center wherein known Wi-Fi™ access points may locate the user through the user's mobile device 90. A user's trajectory may meet conditions for classifying as a vehicle approach. However, the site may have known limited access which is inconsistent with the user's current trajectory. Therefore, the site specific module 213B may provide additional mapping information 250 (e.g., proximity to an exit) relevant to validation of the vehicle approach.

In accordance with an embodiment, approach based module 213 may include a predictive module 213C. The predictive module 213C may also classify the user's trajectory as approaching the vehicle 12 through the naked approach based module 213A and may employ site specific mapping information through the site specific module 213B. Additionally, the predictive module 213C may employ user pattern information 260 useful in validating the vehicle approach based on schedules and/or learned behavior. In an embodiment, a user provided schedule may be employed in validating the vehicle approach based on the schedule and current vehicle and user locations and temporal conditions (e.g., date, time of day, event start/stop times, site visit duration, etc.). A scheduling module 229 may collect a user provided schedule for provision to the predictive module 213C. Such user provided schedule may be received via the various vehicle-user interfaces 50-56 (FIG. 1) and provided to the scheduling module 229. For example, user settings may be provided via push buttons 52, visual display 50, a microphone 54, audio system 56 and voice recognition/dialogue manager, the user's mobile devices 90, etc. In an embodiment, user schedules may be imported or synced from calendar applications on the user's mobile device 90. In accordance with an embodiment, the predictive module 213C may employ machine learning apart from or in conjunction with a user provided schedule in a predictive validation of the vehicle approach based on learned user habits and patterns in accordance with current vehicle location and user location and temporal conditions (e.g., date, time of day, event start/stop times, site visit duration, etc.). A user's trajectory may meet conditions for classifying as a vehicle approach and may further meet site specific criteria as a validated vehicle approach. The additional pattern information 260 based on schedules and/or learned behavior may indicate a low probability that validation of the vehicle approach is proper thus requiring additional accumulated validation cycles for example, or may indicate a high probability that validation of the vehicle approach is proper.

In an embodiment, the predictive module 213C may include a data collection module 215 to log vehicle usage information regarding, for example, site visitations, vehicle origin and destination, and temporal information such as time of day and day of the week. The predictive module 213C may further include a learning module 217 which may include a machine learning model. In an embodiment, the machine learning model of the learning module 217 may include a probabilistic model. One skilled in the art will appreciate that the machine learning model of the learning module 217 may require an initial training period wherein the data collection module 215 and learning module 217 may collect statistically significant training datasets of vehicle usage information and converge the machine learning model solutions. Statistically significant training datasets of vehicle usage information may be defined in terms of time, drive cycles, or other metrics. In addition to the vehicle usage and temporal information, a user provided schedule may provide additional input to the learning module 217 for use in training the machine learning model of the learning module 217. The user provided schedule may be used to initialize or seed the learning module 217. Once trained, the data collection module 215 may collect an additional dataset of vehicle usage information to validate the trained machine learning model of the learning module 217. In other embodiments, the learning module 217 may include a non-probabilistic model. In any case, the learning module 217 may include some type of machine learning model reliant upon a training dataset of vehicle usage information from the data collection module 215. The data collection module 215 may continue to log vehicle usage information and retain such information in updated datasets for periodic validation of the trained machine learning model of the learning module 217 and re-training as may be periodically system or user invoked (e.g., responsive to user schedule changes). The machine learning model, once trained and validated, may be active in the predictive module 213C as an executable model 219.

In one embodiment, all or some of the decision input block 202 of the thermal preconditioning scheduler 200 may be implemented remote from the vehicle 12. For example, the machine learning model of the learning module 217 may be implemented remote from the vehicle 12. As well, the executable model 219 may be implemented remote from the vehicle 12. Training of machine learning models may be performed on computer 78 or server 82 assets provisioned to the vehicle 12. In one embodiment, vehicle usage information from the data collection module 215 may be uploaded and stored in database 84. As described herein, statistically significant training datasets of vehicle usage information are collected in a training phase of the machine learning model of learning module 217. These datasets may be maintained in database 84 and accessed by computer 78 or server 82 which may be configured to train the machine learning model of the learning module 217. Similarly, as described herein, statistically significant validation datasets of vehicle usage information may be collected in a validation phase of the learning module 217. These datasets are also preferably maintained in database 84 and accessed by computer 78 or server 82 for validation of the trained machine learning model of the learning module 217. Fully trained and validated models may be provisioned to the vehicle 12 as an executable model 219 for implementation on one or more VCMs including BCM 24. However, executable model 219 may also be implemented remotely. Subsequent to deployment of fully trained and validated models for implementation on vehicle 12 or remotely, ongoing logs of vehicle usage information may be uploaded and stored in database 84 for periodic validation of the executable models and re-training as may be periodically system or user invoked.

Each of the manual settings module 211, the naked approach based module 213A, the site specific module 213B and the predictive module 213C may be independently enabled within the thermal preconditioning scheduler 200, or the vehicle original equipment manufacturer may limit offering of one or more of the modules in certain vehicles. Certain users may prefer manual control and thus may choose to disable or bypass automated thermal preconditioning controls of the naked approach based module 213A, the site specific module 213B and the predictive module 213C in favor of the manual setting module 211. Similarly, other users may prefer the automated and predictive controls of the predictive module 213C. Other users may prefer some level of automated thermal preconditioning yet lack a regular schedule of vehicle usage. Thus, such a user may enable the naked approach based module 213A or the site specific module 213B features and bypass the manual settings module 211 and the predictive module 213C. It is also understood that such enablements may be hierarchically inclusive. For example, enablement of the predictive module 213C may default to the site specific module 213B when predictive certainty of the machine learning model is low or training. In similar fashion, the site specific module 213B may default to the naked approach based module 213A when site specific information is unavailable. Such enablements among the naked approach based module 213A, the site specific module 213B and the predictive module 213C may be by way of user settings and preferences through the preference module 212.

The thermal preconditioning scheduler 200 may include an executive block 203. The executive block 203 may include a thermal preconditioning tactical module 203A and an approach validation module 203B. The thermal preconditioning tactical module 203A receives inputs from the environmental factors module 201A and the vehicle factors module 201B of the data acquisition block 201 and the preference module 212.

In an embodiment, the thermal preconditioning tactical module 203A is primarily concerned with achieving a thermal preconditioning of the vehicle 12 consistent with the preferences of the user and soft and hard energy limits. Soft limits may be established with respect to user preferences and settings whereas hard limits may be provided as a vehicle calibration for example. Based upon the user preferences (e.g., temperature settings (cabin, seats, etc.)) and information from the environmental factors module 201A and the vehicle factors module 201B of the data acquisition block 201, a total or aggregate energy requirement to achieve the user preference may be determined. Based upon the user preferences (e.g., system priorities) and vehicle configuration, the active thermal preconditioning systems such as the HVAC system (heat/cool/airflow/zoning), thermally regulated seats, arm rests, neck scarf, leg cooler/warmer, steering wheel, and the passive thermal preconditioning systems such as electrically controlled tinting/reflectivity (e.g., smart glass) and window and sunroof controlled venting available and desired by the user for use in thermal preconditioning may be identified and prioritized. Based upon the user preferences (e.g., range reserve, minimum SOC, etc.) and the vehicle battery charge level, state of charge, fuel level and other metrics related to range and/or available energy store in the vehicle 12, an available energy allocation for thermal preconditioning may be established. The available energy store in the vehicle 12 may be less than the total energy store in the vehicle 12 in accordance with a minimum system reserved charge of user preference, for example. Thus, in an embodiment, an aggregate thermal preconditioning energy budget may be established at 209 and may be further allocated to particular systems identified for use in the thermal preconditioning of the vehicle 12. In an embodiment, lower priority systems may be shed or decommissioned where the thermal preconditioning energy budget may be insufficient for actuating all systems.

In an embodiment, the approach validation module 203B is primarily concerned with authenticating a vehicle approach to avoid false invocations of the thermal preconditioning of the vehicle 12 and providing thermal preconditioning rate control information for use by the thermal preconditioning tactical module 203A. Based upon the user preferences 212 (e.g., enablements among the naked approach based module 213A, the site specific module 213B and the predictive module 213C), classification of the user's trajectory as approaching the vehicle, and site specific, schedule or predictive information, evaluation at 206 within the approach validation module 203B may validate a vehicle approach toward the vehicle 12. When the vehicle approach is not validated at 207-N, the approach validation module 203B continues to evaluate at 206 the approach in conjunction with the site specific, schedule or predictive information. When the vehicle approach is validated at 207-Y, the approach validation module 203B may provide an executive trigger and user position, range, and rate information at 208 to the thermal preconditioning tactical module 203A.

In an embodiment, the preconditioning tactical module 203A may begin expending the thermal preconditioning energy budget established at 209 through the user prioritized thermal preconditioning systems when the approach validation module 203B provides the executive trigger. In an embodiment, the energy expenditure may be accomplished in a fashion to synchronize the thermal preconditioning of the vehicle 12 to the user's thermal preconditioning preferences and settings as the user reaches the vehicle for a “just in time” convergence, thus avoiding thermal preconditioning undershoot or overshoot. Such control therefore further relies upon the user position, range, and/or rate information which may enable convergence of the thermal preconditioning completion with the user's arrival time at the vehicle 12 as may be determined in accordance with user position, range from the vehicle, trajectory and rate information. In an embodiment, the aggregate thermal preconditioning energy budget established at 209 may be allocated to particular systems. For example, on a high level, when thermal preconditioning is to cool the cabin air and surfaces, then cabin air and surface heating systems and functions may be decommissioned for use in the present thermal preconditioning control at 210A. Decommissioning of cabin air and surface cooling systems, including selectively by cabin zones, in accordance with the thermal preconditioning energy budget and user priorities may also occur at 210A. Thus, the cooling systems not decommissioned may be allocated a portion of the thermal preconditioning energy budget. Further, when thermal preconditioning is to cool the cabin air and surfaces, then passive systems such as electrically controlled tinting/reflectivity (e.g., smart glass) and window and sunroof venting may be controlled at 214B provided that certain gateway conditions are met at 214A. Gateway conditions may include, for example, acceptable weather (e.g., no precipitation) and location (e.g., secure location). Passive systems may be exempt from thermal preconditioning energy budget decommissioning but subject to user preferences (e.g., geo fencing). In similar fashion, when thermal preconditioning is to heat the cabin air and surfaces, then cabin air and surface cooling systems and functions may be decommissioned for use in the present thermal preconditioning control at 210B. Decommissioning of cabin air and surface heating systems, including selectively by cabin zones, in accordance with the thermal preconditioning energy budget and user priorities may also occur at 210B. Thus, the heating systems not decommissioned may be allocated a portion of the thermal preconditioning energy budget.

The respective allocated portions of the thermal preconditioning energy budget may be scheduled for expensing by the heating and cooling systems at 216. In an embodiment, the allocated portions of the thermal preconditioning energy budget may be expended with synchronized stop times, for example the projected arrival time of the user. In an embodiment, the allocated portions of the thermal preconditioning energy budget may be expended with synchronized start times, for example at the executive trigger provided the approach validation module 203B. In an embodiment, the allocated portions of the thermal preconditioning energy budget may be expended with staggered start times, for example with the largest allocated portions of the thermal preconditioning energy budget being started earlier. In an embodiment, the allocated portions of the thermal preconditioning energy budget may be expended linearly by the respective systems based on the start times and the projected arrival time. The scheduled expensing of the thermal preconditioning energy budget may then be implemented by activating the respective heating and cooling systems at 218. Other expensing tactics may be employed, the examples set forth above being understood as non-limiting specific examples.

The terminology used herein is for the purpose of describing particular embodiments only and is not intended to be limiting. The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

All numeric values herein are assumed to be modified by the term “about” whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally. Similarly, numeric values set forth herein are by way of non-limiting example and may be nominal values, it being understood that actual values may vary from nominal values in accordance with environment, design and manufacturing tolerance, age and other factors.

When an element such as a layer, film, region, or substrate is referred to as being “on” another element, it can be directly on the other element or intervening elements may also be present. In contrast, when an element is referred to as being “directly on” another element, there are no intervening elements present. Therefore, unless explicitly described as being “direct,” when a relationship between first and second elements is described in the above disclosure, that relationship may be a direct relationship where no other intervening elements are present between the first and second elements but may also be an indirect relationship where one or more intervening elements are present (either spatially or functionally) between the first and second elements.

One or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Unless defined otherwise, technical and scientific terms used herein have the same meaning as is commonly understood by one of skill in the art to which this disclosure belongs.

Unless specified to the contrary herein, all test standards are the most recent standard in effect as of the filing date of this application, or, if priority is claimed, the filing date of the earliest priority application in which the test standard appears.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method for thermally preconditioning a vehicle, comprising:
tracking a position of a user and determining a trajectory of the user based upon the user's position;
classifying the user's trajectory as a vehicle approach;
validating the vehicle approach; and
thermally preconditioning the vehicle when the vehicle approach is validated.

2. The method for thermally preconditioning the vehicle of claim 1, further comprising determining an arrival time of the user at the vehicle, wherein a completion of the thermally preconditioning the vehicle converges with the arrival time.

3. The method for thermally preconditioning the vehicle of claim 1, wherein tracking the user's position comprises tracking a position of mobile device of the user.

4. The method for thermally preconditioning the vehicle of claim 1, wherein tracking the user's position comprises tracking a position of a key fob of the user.

5. The method for thermally preconditioning the vehicle of claim 1, wherein classifying the user's trajectory as a vehicle approach is based on a distance of the user's position from the vehicle and the user's trajectory.

6. The method for thermally preconditioning the vehicle of claim 5, wherein classifying the user's trajectory as a vehicle approach is based on the distance of the user's position from the vehicle being less than a predetermined distance from the vehicle and the user's trajectory being within a predetermined angle relative to a straight line between the user and the vehicle.

7. The method for thermally preconditioning the vehicle of claim 1, wherein the user's position comprises a site having known site mapping information, and wherein validating the vehicle approach is based upon the known site mapping information.

8. The method for thermally preconditioning the vehicle of claim 1, wherein validating the vehicle approach is based upon a machine learning model of patterns of the user.

9. The method for thermally preconditioning the vehicle of claim 1, wherein thermally preconditioning the vehicle when the vehicle approach is validated, comprises selectively activating heating or cooling systems of the vehicle based upon preferences of the user.

10. The method for thermally preconditioning the vehicle of claim 1, wherein thermally preconditioning the vehicle when the vehicle approach is validated, comprises selectively activating heating or cooling systems of the vehicle in accordance with a thermal preconditioning energy budget based upon preferences of the user.

11. The method for thermally preconditioning the vehicle of claim 1, wherein thermally preconditioning the vehicle when the vehicle approach is validated, comprises selectively activating heating or cooling systems of the vehicle in accordance with a thermal preconditioning energy budget based upon an available energy store in the vehicle.

12. A method for thermally preconditioning a vehicle, comprising:
acquiring environmental information proximate to the vehicle including acquiring a temperature;
acquiring vehicle specific information including acquiring available heating and cooling systems in the vehicle, a cold soak time of the vehicle, and an available energy store in the vehicle;
acquiring preferences of a user corresponding to heating and cooling system priorities;
acquiring position information of the user from one of a mobile device of the user and a key fob of the user;
determining a trajectory of the user based upon the user's position information; and
thermally preconditioning the vehicle when the user is approaching the vehicle based upon the user's trajectory, the thermally preconditioning the vehicle based upon the temperature, the available heating and cooling systems in the vehicle, the cold soak time of the vehicle, the available energy store in the vehicle and the preferences of the user corresponding to heating and cooling system priorities.

13. The method for thermally preconditioning the vehicle of claim 12, wherein acquiring environmental information proximate to the vehicle further includes acquiring at least one of solar angle and vehicle elevation, and wherein thermally preconditioning the vehicle is further based upon the at least one of solar angle and vehicle elevation.

14. The method for thermally preconditioning the vehicle of claim 12, wherein acquiring vehicle specific information further includes acquiring at least one of orientation of the vehicle and location of the vehicle, and wherein thermally preconditioning the vehicle is further based upon the at least one of orientation of the vehicle and location of the vehicle.

15. The method for thermally preconditioning the vehicle of claim 12, wherein acquiring position information of the user from one of the mobile device of the user and the key fob of the user comprises acquiring position information from at least one of GPS data, cellular data and short-range wireless communications data.

16. The method for thermally preconditioning the vehicle of claim 12, wherein thermally preconditioning the vehicle comprises allocating an aggregate thermal preconditioning energy budget among heating or cooling systems based upon the preferences of the user corresponding to heating and cooling system priorities.

17. The method for thermally preconditioning the vehicle of claim 12, wherein thermally preconditioning the vehicle comprises convergence of a completion of the thermally preconditioning the vehicle with an arrival time of the user at the vehicle.

18. An apparatus for thermally preconditioning a vehicle, comprising:
heating and cooling systems in the vehicle; and
a controller:
acquiring environmental information proximate to the vehicle;
acquiring vehicle specific information;
acquiring preferences of a user;
acquiring position information of the user;
determining a trajectory of the user based upon the user's position information; and
thermally preconditioning the vehicle with the heating or cooling systems in the vehicle when the user is approaching the vehicle based upon the user's trajectory.

19. The apparatus for thermally preconditioning the vehicle of claim 18, wherein the user's position information is acquired from at least one of a mobile device of the user and a key fob of the user.

20. The apparatus for thermally preconditioning the vehicle of claim 18, wherein the thermally preconditioning the vehicle comprises convergence of a completion of the thermally preconditioning the vehicle with an arrival time of the user at the vehicle.
